(19) United States
(12) Patent Application Publication
(10) Pub. No.: US 2005/0128315 A1
(43) Pub. Date: Jun. 16, 2005

(54) Data processing apparatus, data processing method, and computer program

(75) Inventors: Hideki Mori, Tokyo (JP); Shinya Minauchi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 11/007,677

(22) Filed: Dec. 8, 2004

(30) Foreign Application Priority Data
Dec. 10, 2003 (JP) 2003-411613

(51) Int. Cl. H04N 5/225; H04N 5/228

(52) U.S. Cl. 348/222.1

(57) ABSTRACT

A data processing apparatus comprises an imaging element, a processing unit which processes an output from the imaging element, a plurality of operation members, and a control unit which, when a specific one of the operation members is operated, controls the processing unit based on the specific one of the operation members.

### CROSS-REFERENCE TO RELATED APPLICATIONS

This application is based upon and claims the benefit of priority from prior Japanese Patent Application No. 2003-411613, filed Dec. 10, 2003, the entire contents of which are incorporated herein by reference.

### BACKGROUND OF THE INVENTION

1. Field of the Invention

The present invention relates to a data processing apparatus including an imaging function, a data processing method, and a computer program.

2. Description of the Related Art

A data processing apparatus including an imaging function such as a popular digital camera comprises a zoom function, even if operation is comparatively simple. A zoom key is provided in a camera device comprising the zoom function. When one side of this zoom key is pressed down, an object image is gradually enlarged. When the other side of the zoom key is pressed down, an object image is gradually reduced. Therefore, while visually recognizing the object image displayed on a screen, a user operates the zoom key; stops the operation of the zoom key at a time point when a size of the object image reaches a desired size; and then, makes a shutter operation, whereby the object image of the desired size can be picked up.

However, in a conventional data processing apparatus, as described previously, a zoom key is continuously operated, whereby an object image is gradually enlarged or reduced. Thus, a certain amount of time is required for the object image to become the desired size. Therefore, while the object image becomes the desired size, a change occurs with the object, and there is a case in which a shutter chance is lost.

### BRIEF SUMMARY OF THE INVENTION

It is an object of the present invention to provide a data processing apparatus, a data processing method, and a computer program capable of directly change a size of an object image and picking up an object with a desired size by efficiently using an existing key.

According to an embodiment of the present invention, a data processing apparatus including an imaging function comprises:
an imaging device;
a mode setting unit which selectively sets a camera mode and another mode;
operation members which inputs values of a first instruction when the mode setting unit sets the camera mode; and
an image processing unit which, when the camera mode is set and one of the operation members is operated, processes an output of the imaging device based on the value of the first instruction input from the one of the operation members.

According to another embodiment of the present invention, a data processing method for a data processing apparatus including an imaging function and operation members, the method comprises:
a mode setting step which selectively sets a camera mode and another mode;
an inputting step which inputs members values of a first instruction from the operation when the mode setting step sets the camera mode; and
an image processing step which, when the camera mode is set and one of the operation members is operated, processes an output of the imaging device based on the value of the first instruction input from the one of the operation members.

According to still another embodiment of the present invention, a computer program product for use with a data processing apparatus including an imaging device, a mode setting unit which selectively sets a camera mode and another mode, operation members, the computer program product comprises:
means for inputting values of a first instruction by the operation members when the mode setting unit sets the camera mode; and
means for, when the camera mode is set and one of the operation members is operated, processing an output of the imaging device based on the value of the first instruction input from the one of the operation members.

According to still another embodiment of the present invention, a data processing apparatus including an imaging function comprises:
an image pick-upping means;
a mode setting means which selectively sets a camera mode and another mode;
an inputting means with a plurality of operation members which inputs values of a first instruction when the mode setting means sets the camera mode; and
an image processing means which, when the camera mode is set and one of the operation members of the inputting means is operated, processes an output of the image pick-upping means based on the value of the first instruction input from the one of the operation members.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1A is a front view of a cellular phone 1 in an open state common to all embodiments of the present invention;

FIG. 1B is a rear view of the cellular phone 1 in an open state;

FIG. 2 is a block diagram showing a configuration of the cellular phone 1;

FIG. 3A is a conceptual view showing a configuration of a memory area of a program ROM 125;

FIG. 3B is a conceptual view of a ten-key correspondence table 1253;

FIG. 4 is a conceptual view showing a configuration of a memory area of a RAM 124;

FIG. 5 is a flow chart showing operating procedures in the first embodiment of the invention;

FIG. 6 is a view showing an example of a display screen in the first embodiment;

FIG. 7 is a conceptual view of a ten-key correspondence table 1253 in the second embodiment of the invention;

FIG. 8 is a flow chart showing operating procedures in the second embodiment; and

FIG. 9 is a view showing an example of a display screen in the second embodiment.

### DETAILED DESCRIPTION OF THE INVENTION

An embodiment of a data processing apparatus, a data processing method, and a computer program according to the present invention will now be described with reference to the accompanying drawings.

### FIRST EMBODIMENT

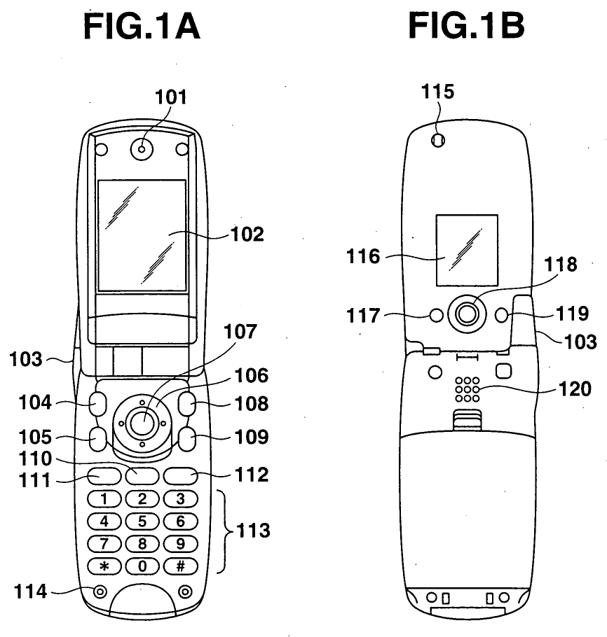

FIGS. 1A and 1B are external views (FIG. 1A is a front view and FIG. 1B is a rear view), each of which shows an open state of a cellular phone 1 common to all embodiments of the present invention. The cellular phone 1 comprises a cover portion and a main body portion which are foldable. An antenna 103 is provided on a rear face of the main body portion, and is expandable. A speaker 101 is provided at a front side of the cover portion, and outputs a voice. A main display unit 102 is provided as a QVGA color liquid display, and is allocated at a substantial center portion of a front face of the cover portion.

On a front face of the main body portion, there are provided a camera key 104; an E-mail key 105; a cross key 106; a determination key 107; an address key 108; a network connection key 109; a clear key 110; an on-hook key; an off-hook key 112; and ten-key 113. In these keys, the cross key, the determination key 107, the address key 108, and the network connection key 109 are allocated in a location which can be operated by a thumb of a one hand, in the case where this cellular phone 1 is gripped by the one hand.

The camera key 104 is operated when a call waiting state is moved to a camera mode and when an image capture element is started up. In addition, this camera key is used for switching between a camera and a movie. The E-mail key 105 is provided as a key which is operated during an E-mail mode shift and during E-mail program loading. The cross key 106 is operated during a cursor movement, and the determination key 107 is operated when a variety of modes are determined. During a camera mode, the determination key 107 functions as a shutter key.

The address key 108 is provided as a key which is operated when address directory data is displayed. The network connection key 109 is provided as an operating key for external network connection. The clear key 110 is provided for cancellation instruction. The ten-key 113 is used for character input and dial input. The ten-key 113 comprises keys assigned with numbers “0” to “9” and keys assigned with signs “*” and “#”.

A microphone 114 is provided at a lower portion of the main body portion, and carries out voice input during phone conversation.

On the rear face of the cover portion, there are provided a recording microphone 115, a sub-display unit 116 including a color liquid crystal, an indicator LED 117 which emits light upon call arrival, an image capture lens 118 provided as an optical system, and a flash LED 119. An informing speaker 120 is provided at a back face of the main body portion. The informing speaker 120 informs call arrival or the like. This informing speaker 120 is allocated on the back face of the main body portion so that an informing sound is audible even in a state in which the cover portion is closed at the main body portion.

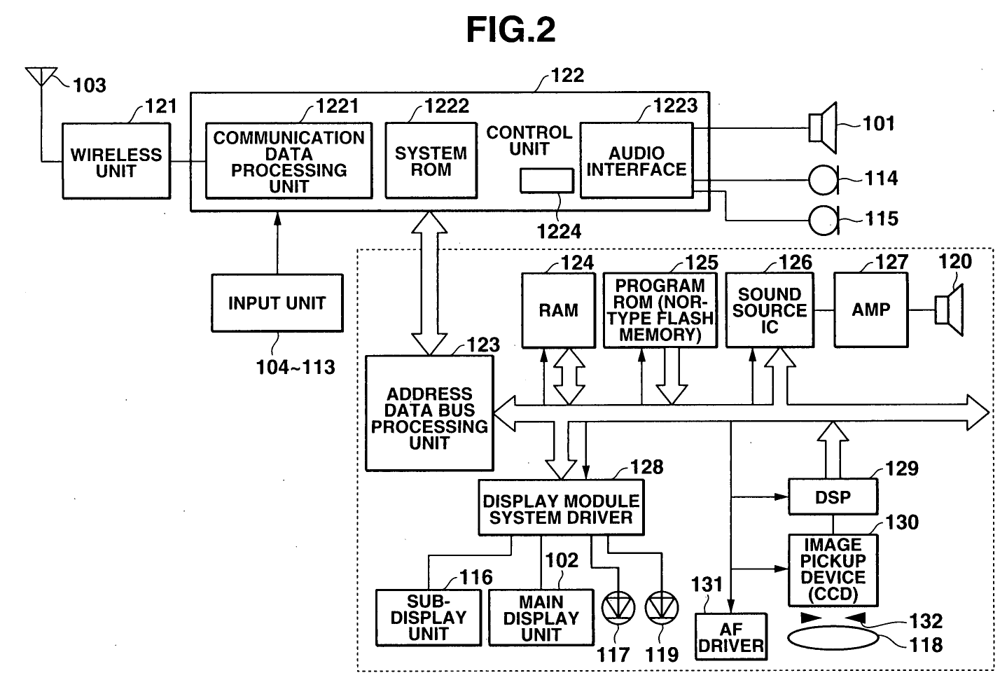

FIG. 2 is a block diagram showing a configuration of the cellular phone 1. A wireless unit 121 is connected to the antenna 103. The wireless unit 121 carries out modulation or demodulation based on a QPSK scheme; transmitting/receiving processing based on a CDMA scheme; and communication processing which includes terminal authentication processing. A control unit 122 controls the device and controls WWW connection. The control unit 121 comprises a communication data processing unit 1221; a system ROM 1222; an audio interface 1223; and a time clocking unit 1224 for clocking a current time based on an incorporated clock (not shown). The communication data processing unit 1221 includes a CLEP system voice decoding/encoding processor circuit; a packet data generator circuit; and a packet data reproduce circuit. The communication data processing unit 1221 carries out data processing along a communication protocol. A basic system such as an OS is stored in the system ROM 1222. The audio interface 1223 inputs or outputs a voice signal processed by the communication data processing unit 1221. The speaker 101, the microphone 114 and the recording microphone 115 are connected to the audio interface 1223. An input unit comprises the camera key 104 through ten-key 113.

An address data bus processing unit 123 controls and manages an input or output timing or the like of data between the control unit 122 and a peripheral circuit (circuit indicated in the dashed line). A RAM 124 stores a variety of data generated in a device such as address directory data or E-mail data. A program ROM (NOR-type flash memory) 125 stores a variety of application programs. In particularly, in the present embodiment, the program ROM 125 stores camera applications including a program for performing compression/encoding processing of image data digitized by a DSP (digital signal processor) 129. A sound source IC 126 stores and outputs a waveform indicating an informing sound. An amplifier 127 amplifies an output from the sound source IC 126, and the informing speaker 120 reproduces this output.

A display module system driver 128 drives the main display unit 102, the sub-display unit 116, the indicator LED 117, and the flash LED 119. An imaging element 130 comprises a CCD or the like in which an object image is focused via an aperture 132 by means of the image capture lens 118. The DSP 129 digitally processes an image signal from the imaging element 130 and enlarges or reduces a size of the image by carrying out digital zoom processing. Based on the output of the DSP 129, the display module system driver 128 drives the main display unit 102, whereby the object image focused on the imaging element 130 is displayed to be enlarged or reduced on the main display unit 102. In addition, in accordance with a shutter operation, the image data on the object image is recorded in an image memory 1243 described later.

The image capture lens 118 is held by a drive mechanism (not shown) which comprises a stepping motor or the like for auto focus control. According to a control signal based on a passive AF in a contrast detecting scheme from the control unit 122, a drive signal output by an AF driver 131 is supplied to the drive mechanism, whereby a focusing operation is made by moving the image capture lens 118 forwardly or backwardly along an optical axis. The aperture 132 is of fixed type in which an aperture value has been set so that pan focusing can be carried out.

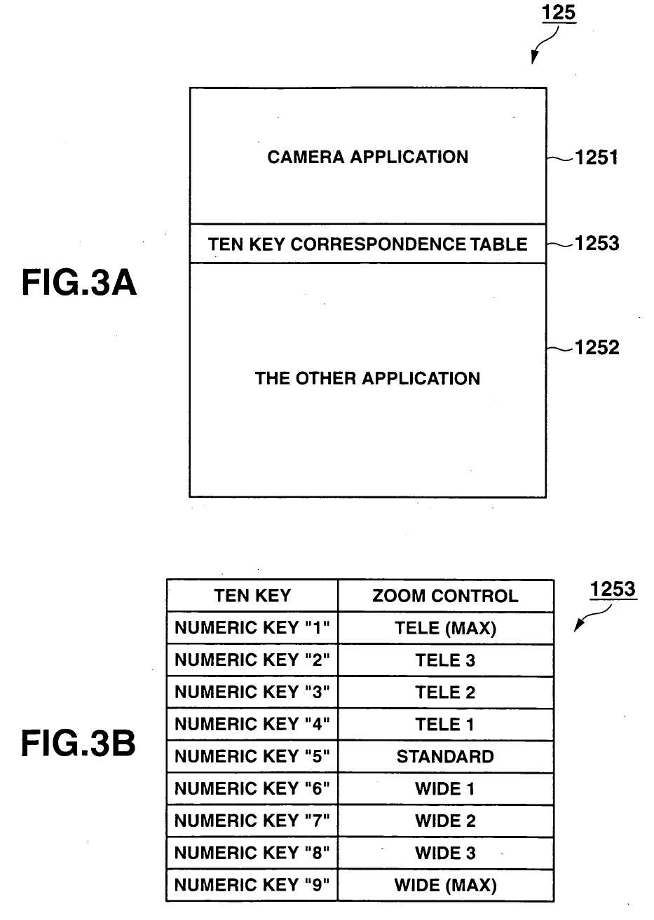

FIG. 3A is a conceptual view showing a configuration of a memory area of the program ROM 125. The program ROM 125 includes a software program storage region 1251; a ten-key correspondence table 1253; and the other storage region 1252. The software application storage region 1251 stores camera applications. The other storage region 1252 stores the other applications. In the ten-key correspondence table 1253, as shown in FIG. 3B, the contents of zoom control from “tele (max)” (maximum enlargement) to “wide (max)” (minimum reduction) are stored in a stepwise manner in association with numeric value keys “1” to “9” in the ten-key 113.

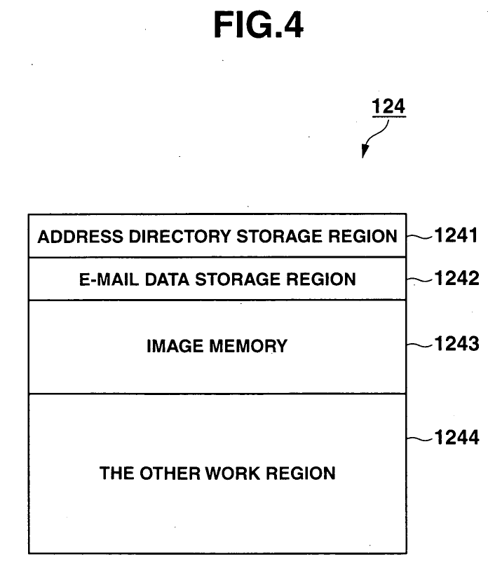

FIG. 4 is a conceptual view showing a configuration of a memory area of the RAM 124. The RAM 124 includes an address directory storage region 1241; an E-mail data storage region 1242; an image memory 1243; and the other work region 1244. The address directory storage region 1242 stores a plurality of records, each record comprising a name, a telephone number, an E-mail addresses and the like. The E-mail data storage region 1242 stores E-mail data produced by using E-mail software or received E-mail data. The image memory 1243 stores an image file of a picked-up image. The other work region 1244 stores a variety of data as a work memory.

Now, an operation of the cellular phone 1 according to the above configuration will be described below. In a call waiting state, the cellular phone 1 functions in the same manner as a general cellular phone. Namely, as described previously, the E-mail key 105 functions as a key operated during an E-mail mode shift and during E-mail program loading. The address key 108 functions as a key operated when address directory data is displayed. The network connection key 109 functions as an operating key for external network connection. The ten-key 113 functions as character input and dial input keys.

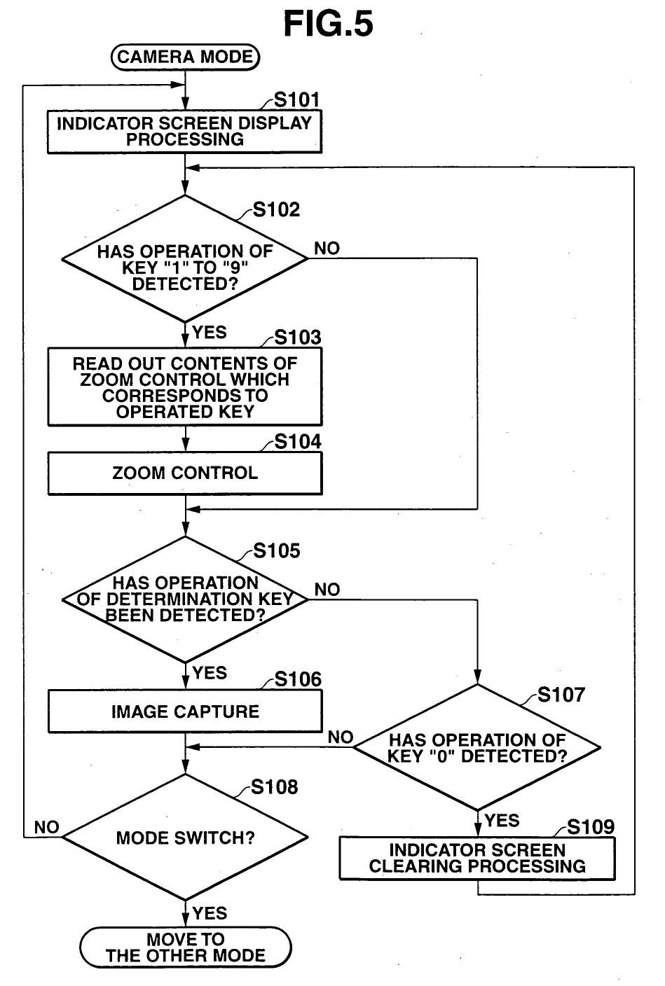

When a user operates the camera key 104 with one touch in order to use the cellular phone 1 as a camera, a mode of the control unit 122.shifts to a camera mode in response to the operation of this camera key 104. Then, the control unit 122 loads a camera application stored in the software program storage region 1251. With the shift to the camera mode, the control unit 122 controls the main display unit 102 to monitor and display in a “tele 1” mode the object image focused on the imaging element 130 by means of the image capture lens 118 in an auto focus (AF) mode. Then, the control unit 122 executes processing as shown in the flow chart of FIG. 5 based on a program stored in the program ROM 125 while the control unit 122 controls the main display unit 102 to display the object image.

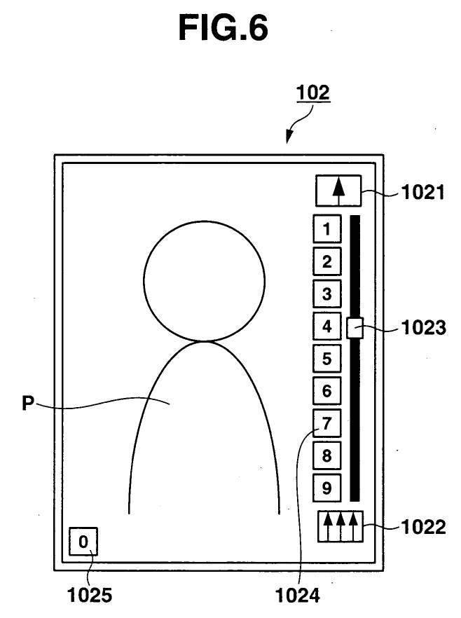

Indicator screen display processing is executed (step S101). By carrying out processing in step S101, as shown in FIG. 6, a tele-side mark 1021, a wide-side mark 1022, a zoom location indicator 1023 between both of the marks 1021 and 1022, numbers “1” to “9” portions 1024 located along the movement direction of the indicator 1023, a lower left 0-numbered portion 1025 and the like are displayed on the main display unit 102 on which an object image P is monitored and displayed.

At this time, the zoom location indicator 1023 is caused to indicate a number in coincidence with a number of the ten-key 113 which correspond to a value of zoom control at a current time point. Namely, in an initial display state, the object image is monitored and displayed in a “tele 1” mode. This “tele 1” mode corresponds to the numeric key “4”, as shown in FIG. 3B. Thus, as shown in FIG. 6, the zoom location indicator 1023 is caused to indicate a number in a location which corresponds to a number “4”. Therefore, with reference to the screen shown in FIG. 6, the user can recognize that the object image P is adjusted so as to be displayed to be enlarged according to the selected number if any one of the numbers “1” to “3” which is smaller than the number “4” is selected. On the other hand, the user can recognize that the object image P is adjusted so as to be displayed to be reduced according to the selected number if any one of the numbers “5” to “9” which is larger than the number “4” is selected.

Next, it is determined whether or not an operation of any one of the numeric keys “1” to “9” in the ten-key 113 has been detected (step S102). When the determination result is affirmative, the contents of zoom control corresponding to the operated numeric key are read out from the ten-key correspondence table 1253 (step S103). For example, when an operation of the numeric key “1” in the ten-key 113 has been detected, an item “tele (max)” is read from the ten-key correspondence table 1253. When the numeric key “7” has been operated, an item “wide 2” is read out.

Continuously, the DSP 129 is controlled based on the read out control contents, and image data is subjected to digital zoom processing based on the read zoom level (step S104). In this manner, the object image enlarged or reduced according to the operated numeric key is displayed quickly on the main display unit 102. Further, it is determined whether or not the determination key 107 has been operated (step S105). In a camera mode, in the case where the determination key 107 has been operated, image capture is carried out in that state (step S106).

When the determination key 107 is pressed down, image data on the object image enlarged or reduced by the DSP 129 at this time is compressed and encoded by using a camera application. Then, an image file is produced, and the image file is stored in the image memory 1243 while the date and time of image capture is defined as a file name. Therefore, the user can visually recognize the object image P displayed to be enlarged or reduced on the main display unit 102 by operating one of arbitrary numeric keys “1” to “9” of the ten-key 113. Then, the user can carry out image capture such that the image data on the object image P displayed on the enlarged or reduced mode is stored in the image memory 1243 without losing a shutter chance, by operating the determination key 107.

As a result of the determination in step S105, when the determination key 107 is not detected as having been pressed down, it is determined whether or not an operation of the numeric key “0” in the ten-key 113 has been detected (step S107). When an operation of the numeric key “0” has not been detected (step S107) or when image capture processing has been carried out (step S106), it is determined whether or not a mode change has been made (step S108). When the mode change has been made, camera processing in accordance with this flow of operation is terminated. When no mode change has been made, the current step returns to step S101 in which processing is repeated.

On the other hand, as a result of the determination in step S107, when the operation of the numeric key “0” in the ten-key 113 has been detected, the indicator screen is erased (step S109), and then processing is returned to step S102. By carrying out the processing in step S109, all of the tele-side mark 1021, the wide side mark 1022, the zoom location indicator 1023, “1” to “9”-numbered portions 1024; and a “0”-numbered portion 1025 are cleared from the main display unit 102 shown in FIG. 6. In this manner, only the object image P is displayed on the main display unit 102, and the object image P can be displayed in an easily visible state on the main display unit 102.

As described previously, even in this case, the processing from step S102 is executed. Thus, the object image P is displayed to be enlarged or reduced according to the operation of any one of the numeric keys “1” to “9” in the ten-key 113, whereby image capture can be carried out.

### SECOND EMBODIMENT

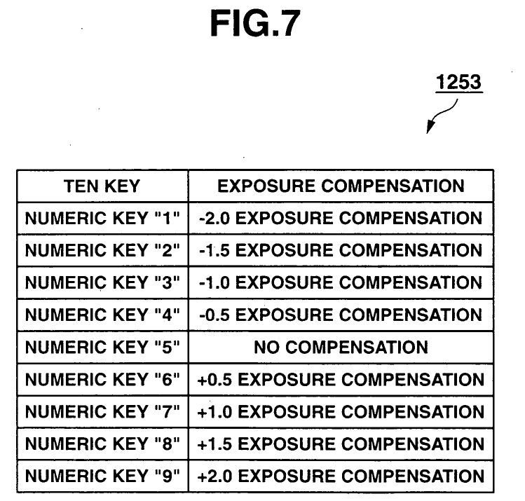

FIG. 7 is a view showing a configuration of a ten-key correspondence table 1253 in the second embodiment of the present invention. In the ten-key correspondence table 1253 according to the present embodiment, exposure compensation values from “−2.0 exposure compensation” (maximum exposure compensation in minus side) to “+2.0 exposure compensation” (minimum exposure compensation in plus side) are stored in a stepwise manner in association with the numeric keys “1” to “9” in the ten-key 113.

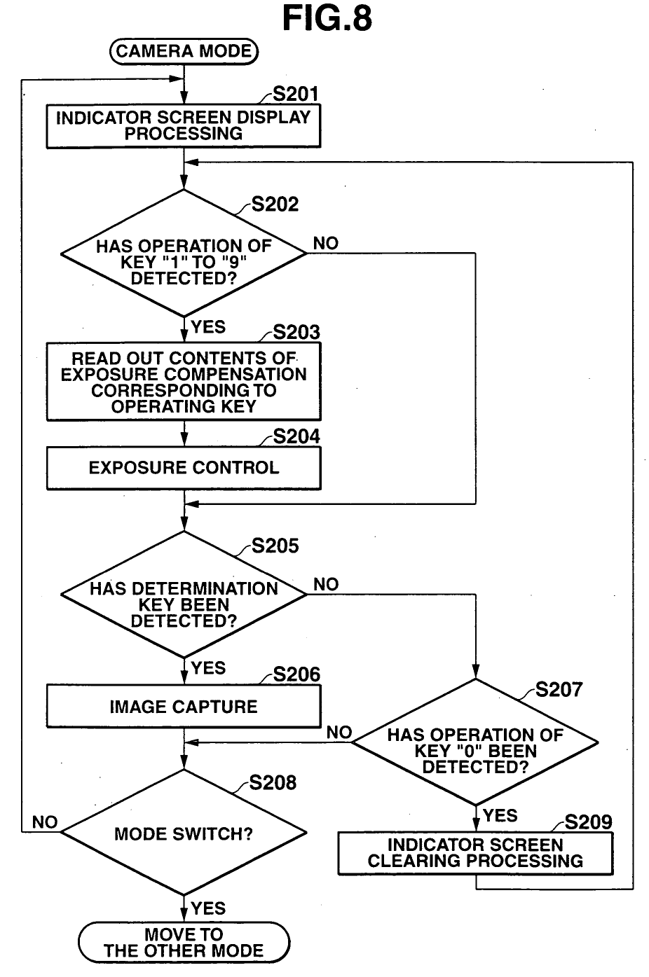

FIG. 8 is a flow chart showing operating procedures in the present embodiment. That is, when a user operates the camera key 104 with one touch in order to use the cellular phone 1 as a camera, a mode of the control unit 122 shifts to a camera mode in response to an operation of the camera key 104. Then, the control unit 122 loads a camera application stored in the software program storage region 1251. With the shift to the camera mode, the control unit 122 controls the main display unit 102 to monitor and display in a “+0.5 exposure compensation” mode an object image focused on the imaging element 130 by means of the image capture lens 118 in an auto focus (AF) mode. Then, the control unit 122 executes processing as shown in the flow chart of FIG. 8 based on a program stored in the program ROM 125 while the control unit 122 causes the main display unit 102 to display the object image.

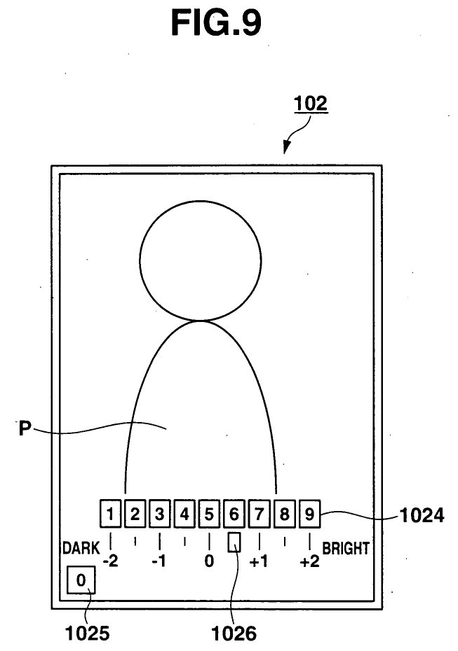

First, indicator screen display processing is executed (step S201). By carrying out processing in step S201, as shown in FIG. 9, an exposure compensation value indicator 1026 indicating a mode from “dark” to “bright”; “1” to “9”-numbered portions 1024 located along the movement direction of this indicator 1026; a lower left “0”-numbered portion 1025 and the like are displayed on the main display unit 102 on which the object image P is monitored and displayed.

At this time, the exposure compensation value indicator 1026 indicates a number in coincidence with a number of the ten-key 113 which corresponds to a value of exposure compensation at the current time point. Namely, in an initial display state, as described previously, the object image is monitored and displayed in a “+0.5 exposure compensation” mode. This “+0.5 exposure compensation” mode corresponds to a numeric key “6”, as shown in FIG. 7. Thus, the exposure compensation value indicator 1026 is caused to indicate a number in a location which corresponds to the number “6”, as shown in FIG. 9. Therefore, with reference to the screen shown in FIG. 9, the user can recognize that the object image P is adjusted so as to be displayed to be displayed in a dark mode according to the selected number if any one of the numbers “5” to “1” which is smaller than the number “6” is selected. On the other hand, the user can recognize that the object image P is adjusted so as to be displayed to be displayed in a bright mode according to the selected number if any one of the numbers “7” to “9” which is greater than the number “6” is selected.

Now, it is determined whether or not an operation of any one of the numeric keys “1” to “9” in the ten-key 113 has been detected (step S202). When the determination result is affirmative, the contents of exposure compensation corresponding to the operated numeric key are read out from the ten-key correspondence table 1253 (step S203). Namely, when an operation of a numeric key “1” in the ten-key 113 has been detected, an item “−2.0 exposure compensation” is read out from the ten-key correspondence table 1253. When a numeric key “7” has been operated, an item “+1.0 exposure compensation” is read out.

Continuously, the DSP 129 is controlled according to this read-out control contents, and image data is subjected to digital exposure processing based on the read exposure compensation level (step S204). In this manner, an object image subjected to exposure compensation processing according to an operated numeric key is quickly displayed on the main display unit 102. Further, it is determined whether or not the determination key 107 has been operated (step S205). Then, in a camera mode, when the determination key 107 has been operated, image capture is carried out in that state (step S206).

Namely, when the determination key 107 is pressed down, the image data on the object image subjected to exposure compensation processed by means of the DSP 129 at that time point is processed to be compressed and encoded by a camera application. Then, an image file is generated, and the generated image file is stored in an image memory 1243 while the date and time of image capture are defined as a file name. Therefore, the user can visually recognize the object image displayed to be exposure-compensated on the main display unit 102 by operating an arbitrary numeric key “1” to “9” of the ten-key 113. Then, the user can carry out image capture such that the image data on the object image P displayed on the exposure compensation mode is stored in the image memory 1243 without losing a shutter chance, by operating the determination key 107.

As a result of the determination in step S205, when the determination key 107 is not detected as having been pressed down, it is determined whether or not an operation of the numeric key “0” in the ten-key 113 has been detected (step S207). When an operation of the numeric key “0” has not been detected or when image capture processing has been carried out (step S206), it is determined whether or not a mode change has been made (step S208). When the mode-change has been made, camera processing in accordance with this flow of operation is terminated. When no mode change has been made, the current step returns to step S201 in which processing is repeated.

On the other hand, as a result of the determination in step S207, when the operation of the numeric key “0” in the ten-key 113 has been detected, the indicator screen is cleared (step S209), and then processing is returned to step S202. By carrying out the processing in step S209, all of the exposure compensation value indicator 1026; the “1” to “9”-numbered portions 1024; the lower left “0”-numbered portion 1025 are cleared from the main display unit 102 shown in FIG. 9. In this manner, only the object image P is displayed on the main display unit 102, and the object image P can be displayed in an easily visible state on the main display unit 102.

As described previously, even in this case, the processing from step S202 is executed. Thus, the object image P is displayed to be exposure-corrected according to the operation of any one of the numeric keys “1” to “9” in the ten-key 113, whereby image capture can be carried out.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, although the embodiments have been described as a cellular phone, the present invention can be applied to other comparatively small sized devices which have an image capture function such as a PDA, a digital camera, and a portable type game machine.

1. A data processing apparatus including an imaging function comprising:
an imaging device;
a mode setting unit which selectively sets a camera mode and another mode;
operation members which inputs values of a first instruction when the mode setting unit sets the camera mode; and
an image processing unit which, when the camera mode is set and one of the operation members is operated, processes an output of the imaging device based on the value of the first instruction input from the one of the operation members.

2. A data processing apparatus according to claim 1, further comprising a communication device and wherein the one of the operation members inputs values of a second instructions for the communication device when the other mode is set.

3. A data processing apparatus according to claim 1, further comprising a storage unit which stores the values of the first instruction in correspondence with the operation members.

4. A data processing apparatus according to claim 1, further comprising a display device which displays the values of the first instruction in correspondence with the operation members.

5. A data processing apparatus according to claim 1, wherein the image processing unit subjects the output from the imaging device to a zoom processing and the operation members input values of the first instruction indicating zoom levels.

6. A data processing apparatus according to claim 1, wherein the image processing unit subjects the output from the imaging device to an exposure compensation processing and the operation members input values of the first instruction indicating exposure compensation levels.

7. A data processing apparatus according to claim 1, wherein the operation members comprise dial keys.

8. A data processing method for a data processing apparatus including an imaging device and operation members, the method comprising:
a mode setting step which selectively sets a camera mode and another mode;
an inputting step which inputs members values of a first instruction from the operation when the mode setting step sets the camera mode; and
an image processing step which, when the camera mode is set and one of the operation members is operated, processes an output of the imaging device based on the value of the first instruction input from the one of the operation members.

9. A computer program product for use with a data processing apparatus including an imaging device, a mode setting unit which selectively sets a camera mode and another mode, operation members, the computer program product comprising:
means for inputting values of a first instruction by the operation members when the mode setting unit sets the camera mode; and
means for, when the camera mode is set and one of the operation members is operated, processing an output of the imaging device based on the value of the first instruction input from the one of the operation members.

10. A data processing apparatus including an imaging function comprising:
image pick-upping means;
mode setting means for selectively setting a camera mode and another mode;
inputting means, having a plurality of operation members, for inputting values of a first instruction when the mode setting means sets the camera mode; and
image processing means, when the camera mode is set and one of the operation members of the inputting means is operated, for processing an output of the image pick-upping means based on the value of the first instruction input from the one of the operation members.
